(19) United States
(12) Patent Application Publication
(10) Pub. No.: US 2023/0272581 A1
(43) Pub. Date: Aug. 31, 2023

(54) METHODS OF TREATING A KRAFT PROCESS RECOVERY CYCLE TO REDUCE METAL LEVELS AT THE KRAFT PROCESS

(71) Applicant: SUZANO S.A., Salvador - Bahia (BR)

(72) Inventors: Heloisa Ogushi Romeiro RAMIRES, Aracruz, Espirito, Santo (BR); Thiago Silva Pinto DE FARIA, Aracruz, Espirito, Santo (BR)

(73) Assignee: SUZANO S.A., Salvador - Bahia (BR)

(21) Appl. No.: 17/926,825

(22) PCT Filed: May 24, 2021
(86) PCT No.: PCT/BR2021/050222

§ 371 Date: Nov. 21, 2022

Related U.S. Application Data
(60) Provisional application No. 63/029,075, filed on May 22, 2020.

(51) Int. Cl. D21C 11/00; D21C 11/04; D21C 11/10

(52) U.S. Cl. CPC D21C 11/0085; D21C 11/04; D21C 11/10

(57) ABSTRACT

The present invention is related to a method for: reducing metals content in a Kraft pulping process comprising adding magnesium to a black liquor that is returned to the pulping operation; reducing aluminum content in a pulping process by adding magnesium to the black liquor to provide a green liquor having a specific molar ratio of magnesium:aluminum; producing or treating a green liquor having a specific molar ratio of magnesium:aluminum by adding magnesium to the black, weak black, strong black liqueurs; and producing hydrotalcite by the addition of at least 0.04-5.0 mols of magnesium:aluminum present at the weak black, strong black liqueurs, or a combination thereof. It is also provided a pulp mill comprising a digester (1), a washer (2), an optionally pulp bleaching, a weak black liquor concentrator (4), among other parts.

### FIELD OF INVENTION

The present invention relates to treatment methods of a Kraft process spent liquors to reduce metal levels in the Kraft process.

### BACKGROUND

High levels of inorganic metals, particularly, aluminum in Kraft pulping process and recovery cycle are extremely detrimental to the processes.

Aluminum may be introduced in the Kraft process from the production inputs contaminated with aluminum, such as calcium oxide, wood, soil, water, chemicals, and others. For example, aluminum may be introduced in the Kraft process via wood coming from soils in general, which may have up to 150,000 ppm of aluminum. Aluminum may be introduced in the Kraft process adhered to the surface of the logs, which ends up being incorporated into the chip fed into the digester.

High levels of aluminum contamination are detrimental for the pulping process. Accumulation of aluminum, iron and manganese, for example, in the operation pipelines causes differentials in local temperatures, which may lead to fragilities in the pipeline shell and/or further fracture or clogging in the system, which tends to be relevant for very high-throughput operations that imposes elevated pulp mass flows and, consequently, accelerated aluminum accumulation. For instance, at the kiln furnace, previously to the application of the present methods, a cleaning purge of mud, with an average concentration of 900 ppm of solids, a total of about 2,300 kg of aluminum was found.

One particular problem associated with the aluminum contamination is that it can cause deposits in evaporations, when reacted with silica, causing loss of efficiency and possible stops in the system. The loss of filterability in mud filters, during the caustification, when accumulated in an excessive way is another common problem related to the aluminum contamination. Further, when it occurs in the white liquor an increase in the concentration in the final product is observed.

Aluminum is soluble in white liquor and directly treating the white liquor to remove aluminum before or during the digestion is difficult because, typically, there are no concentration steps leading to aluminum dregs that could be removed immediately before, or immediately after, the digestion step, and installing one such operation could lead to increased costs.

A number of studies investigating the removal of inorganic metals, in particular, the aluminum, have been published. For example, Ulmgren, 1987 describes that by adding magnesium sulfate to the dissolving tank, it would be possible to reduce the concentration of soluble aluminum in the green liquor. Similarly, Wannenmacher et al., 2005 studied the solubility of aluminosilicates in Kraft green and white liquors (GL and WL, respectively). Specifically, the addition of magnesium sulfate to the green liquor was evaluated. This study revealed that Al and Si were removed from the GL through precipitation processes. However, the use of magnesium sulfate at these points in the process is ineffective for the removal of aluminum and, in addition, may lead to the risk of loss of filterability of the liquor.

Thus, it is still necessary to develop methods that are effective for the removal of inorganic metals, especially aluminum, so that, the risks of loss of filterability and of stops in the system are reduced when using such specific method.

The inventors developed methods that capture aluminum during the black liquor recovery operation, which is returned to the Kraft operation, which was found more favorable, resulting in better aluminum removal for the whole pulping process.

### BRIEF DESCRIPTION OF THE INVENTION

The present invention is related to a method for reducing aluminum content in a Kraft pulping process comprising adding at least one form of magnesium to a black liquor that is returned to the Kraft pulping operation. Also, it is provided a method for reducing aluminum content in a pulping process by adding of at least one form of magnesium to the black liquor to provide a green liquor having a molar ratio proportion of magnesium to aluminum of 0.04-5.0, preferably of 3.0-5.0, more preferably, of 4.0 and a method of producing or treating a green liquor having a molar ratio of magnesium to aluminum of at least 1.0, preferably 4.0, by adding at least a magnesium form to the black liquor, weak black liquor, or strong black liquor. It is also provided a Kraft pulp mill comprising a digester plant 1, a washer plant 2, an optionally pulp bleaching plant, a weak black liquor concentrator plant 4, a recovery boiler plant 5, a causticizing plant 6 and a magnesium addition unit. It is also revealed a method of producing hydrotalcite by the addition of at least 0.04-5.0, preferably of 3.0-5.0, more preferably, of 4.0 magnesium mols to the aluminum mol present at the weak black liquor, strong black liquor, or a combination thereof.

### BRIEF DESCRIPTION OF THE DRAWINGS

FIG. 1 is a depiction of a Kraft a pulp mill.

FIG. 2 shows the reduction of the aluminum content in the green liquor in time.

### DETAILED DESCRIPTION OF THE INVENTION

The inventors developed methods that capture aluminum during the black liquor recovery operation, which was found more favorable resulting in better aluminum removal and in a Kraft process with lower levels of aluminum. Furthermore, the methods of the present invention reduce the risks of loss of filterability and of stops in the Kraft process.

The methods of the present invention are equally applicable to reduce iron and manganese levels.

For the purposes of the present invention, aluminum is to be understood as aluminum in any form, such as free aluminum, aluminum as a cation, oxide, hydroxide, and/or salt. For instance, aluminum as Al³+, Al₂O₃.

Removing aluminum is meant to be understood as making aluminum less available at a medium, i.e., decreasing the aluminum amount in a medium (i.e., black liquor) by physically removing or providing aluminum as a water insoluble compound, etc., i.e., hydrotalcite.

White liquor is a strongly alkaline solution mainly of sodium hydroxide and sodium hydrosulfide. It is used in the first stage of the Kraft process in which lignin and hemicellulose are separated from cellulose fiber for the production of pulp. The white liquor helps break the bonds between lignin and cellulose.

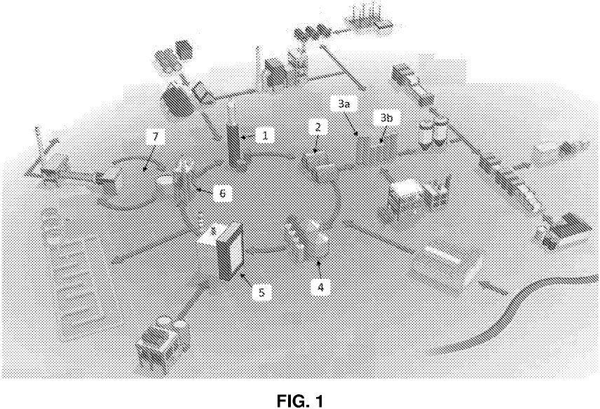

As shown in FIG. 1, at Kraft pulp mills, wood chips are cooked in digesters 1 at high temperature and pressure (typically from 145 - 160 centigrade and up to 7-11 bars, respectively) with white liquor (a mixture of sodium hydroxide and sodium hydrosulphide) which is produced in the mill’s causticizing plant 6 in order to break down and remove lignin from the wood chips.

Using this process, fibers composed mostly of cellulose and hemicellulose are typically produced in the form of a brown pulp of mainly spent liquor and cellulose pulp, which is further typically pre-bleached at 3a and bleached at 3b, dried and sold to market for the manufacture of various paper products. The lignin removed from the wood chips during the pulping and subsequent pulp washing processes, typically ends up in the residual pulping liquor (weak black liquor) which is concentrated from 15 to 80 percent solids using multiple-effect evaporators at a concentrator plant 4, producing strong black liquor.

The strong black liquor is then led to the boiler plant 5 where the organics in strong black liquor are combusted thereby producing carbon dioxide, water and heat. The heat produced in the recovery furnace is used to produce steam and power for internal mill use. During the combustion process, the inorganics in the strong black liquor are converted to sodium carbonate and sodium sulphide which come out from the recovery furnace in the form of molten smelt. This smelt is dissolved in water (or other aqueous mill streams) to form green liquor (a solution of sodium carbonate and sodium sulphide). Sodium sulphide is then converted to white liquor (a solution of sodium hydroxide and sodium sulphide) through the addition of calcium oxide from the lime kiln in the mill’s causticizers 6.

A by-product of this reaction is calcium carbonate which is sent back to the causticizers 6 for re-conversion to calcium oxide by calcining at high temperatures. White liquor is thus produced for reuse in the wood chip pulping process 1. Using this chemical recovery process, typically over 95 percent of the chemicals needed in pulping may be recovered. This recovery cycle is presently understood as the black liquor recovery operation. A small amount of process chemicals is lost during pulp washing (carried over to the bleach plant with the pulp) and as a result of other losses from the Kraft recovery cycle such as spills and leaks from different pieces of equipment as well as the dregs and grits being directed to landfill. The lost sodium and sulphur values are usually made up through the addition to the chemical recovery cycle of purchased sodium hydroxide and sodium sulphate by-product from the mill’s chlorine dioxide generator. A typical 1000 ton/d Kraft pulp mill adds 10-20 ton/d of sodium hydroxide and about 20-40 ton/d of sodium sulphate as make-up chemicals to the chemical recovery cycle. The exact amounts to be added is determined based on the tightness of the chemical recovery cycle with respect to liquor losses while the ratio of the two make-up chemicals is based on the Na/S ratio in the mill’s white liquor which is usually kept constant.

During the pulp washing process, sulphuric acid is used followed by a water wash 2. In this process, the sulphuric acid reacts with sodium ligninates (sodium cations associated with the phenolic and carboxyl groups in lignin) and sodium bicarbonate to convert them to sodium sulphate which ends up in the Kraft recovery cycle via the filtrate from the lignin dewatering and washing steps. Since sodium ligninates and carbonates would have been converted to sodium hydroxide if they had not been exposed to sulphuric acid, the sodium hydroxide requirements of mills with lignin plants increase to an extent largely determined by the amount of sulphuric acid used in the lignin-washing process.

The objective of the present invention is to provide a method for reducing aluminum content in a Kraft pulping process comprising adding at least a magnesium to a black liquor that is returned to the Kraft operation, specifically by adding at least a magnesium form to the weak black liquor, or the strong black liquor.

It is also an objective of the present invention to provide a method for reducing iron and manganese content in a Kraft pulping process.

For the purposes of the present invention, aluminum is to be understood as the aluminum as found in any form, such as free form, as a cation form or incorporated in any compounds such as salts, oxides or hydrates, solvates or in any other form or mixtures thereof. Accordingly, the magnesium is also to be understood as the magnesium element and may be in any form of magnesium, that is, in a free form, a cation form, a salt form, an oxide form, or in any other form or mixtures thereof.

The addition of magnesium may be performed by any means and typically is performed using magnesium sulphate, i.e., using a feeding belt carrying the magnesium, or by simply dissolving compounds comprising the magnesium into the medium to be treated.

As discussed, the black liquor resulting from the pulping operation is treated in a recovery operation and the inorganics are converted for further re-use in the pulping process. Also, in some instances the black liquor may be used directly as an input at any step of the Kraft pulping process or at any plant of the Kraft a pulping mill. In any case, the black liquor could be returned to the pulping operation instead of being discarded as a residual by-product.

The black liquor is the waste product from the Kraft process when digesting pulpwood into paper pulp removing lignin, hemicelluloses and other extractives from the wood to free the cellulose fibers. The black liquor is understood to be the black liquor resulting from the spend liquors, the weak black liquor or the strong black liquor that, when treated, results in a green liquor.

Typically, when using input materials contaminated with aluminum, the black liquor will carry this contamination and produce detrimental effects in the pulping process, even at low levels.

In this sense, in one aspect of the present invention the magnesium is added to a black liquor that is returned to the Kraft operation, preferably after a black liquor recovery operation that typically results in a green liquor.

In said aspect, the method of reducing aluminum content in a Kraft process is achieved by adding at least a magnesium to a black liquor that is returned to the pulping operation. The Kraft process is to be understood as the digestion process and the whole spent liquor recovery cycle.

For instance, if the black liquor is a weak black liquor, magnesium may be added to the weak black liquor before the evaporation step, before entering, or at the concentrator plant 4 for producing a strong black liquor. If the black liquor is a strong black liquor, magnesium may be added to the strong black liquor before the concentration step, before entering, or at the boiler plant 5 before producing a green liquor. This may be done by a dedicated magnesium feeding line or using any other feeding line already present at the operation. In one aspect, the magnesium is added at the sesquisulfate feeding line.

The weak black liquor is conducted for evaporation at the concentrator plant 4 and the magnesium may be added into the weak black liquor in a molar proportion of magnesium to aluminum present at the weak black liquor of at least 1, preferably at least 3, more preferably at least 4.

Alternatively, the strong black liquor is conducted for concentration at the boiler plant 5 and the magnesium may be added into the strong black liquor in a molar proportion of magnesium to aluminum present at the strong black liquor of at least 1, preferably at least 3, more preferably at least 4.

Accordingly, both weak black liquor and strong black liquor may receive the magnesium.

In one aspect, the methods of the present invention disclose an addition of magnesium at a molar ratio proportion from 0.04 to 5.0 mol, preferably from 3.0-5.0, more preferably, of 4.0 of magnesium to each aluminum mol, at the black liquor. Accordingly, both weak black liquor and strong black liquor may receive the magnesium.

For instance, if the black liquor is a weak black liquor, magnesium may be added at the weak black liquor before the weak black liquor evaporation step, i.e., before entering, or at, the evaporation plant 4 for producing a strong black liquor. The weak black liquor is conducted for evaporation at a boiler plant 4 and the magnesium may be added into the weak black liquor in amounts of 0.04-5.0 mol, preferably of 3.0-5.0, more preferably of 4.0 of magnesium for every mol of aluminum present at the weak black liquor. In one aspect, magnesium is added in a molar ratio proportion of 1 mol of magnesium to each mol of aluminum at the weak black liquor, preferably in a molar ratio proportion of 3 mol of magnesium to each mol of aluminum at the weak black liquor, more preferably in a molar ratio proportion of 4 mol of magnesium to each mol of aluminum at the weak black liquor.

For instance, if the black liquor is a strong black liquor, magnesium may be added at the strong black liquor before the strong black liquor concentration step, i.e., before entering, or at, the boiler plant 5 for producing a green liquor. The strong black liquor is conducted for concentration at a boiler plant 5 and the magnesium may be added into the strong black liquor in amounts of 0.04-5.0 mol, preferably of 3.0-5.0, more preferably, of 4.0 of magnesium for every mol of aluminum present at the strong black liquor. In one aspect, magnesium is added in a proportion of 0.3 mol of magnesium to each mol of aluminum at the black liquor, preferably in a proportion of 3 mol of magnesium to each mol of aluminum at the black liquor, more preferably in a proportion of 4 mol of magnesium to each mol of aluminum at the black liquor.

Typically, the methods for reducing aluminum content in a Kraft process by adding at least a magnesium to the black liquor of the present invention provides a green liquor having a molar proportion of magnesium to aluminum of at least 1, preferably at least 3, more preferably at least 4.

Accordingly, the methods for reducing aluminum content in a pulping process by adding of at least a magnesium to a black liquor provide a treated white liquor having aluminum amounts up to 60 ppm, preferably up to 30 ppm, more preferably up to 20 ppm. Typically, treating for aluminum at the black liquor yields a white liquor with lower levels of aluminum, resulting in less aluminum present at the Kraft digestion operation and recovery cycle.

In one embodiment, the methods of the present invention disclose adding at least a magnesium to the black liquor to provide a green liquor having a molar ratio of magnesium to aluminum of at least 1, preferably at least 4, which tend to result in a pulping process with lower levels of aluminum.

To achieve such results, the present method produces a green liquor having a molar ratio of magnesium to aluminum of at least 3, preferably at least 4. If the magnesium is added to the green liquor, the method provides a treated green liquor having a molar ratio of magnesium to aluminum of at least 3, preferably at least 4.

In another aspect of the present invention, there is also provided a Kraft a pulp mill with a digester 1, a washer plant 2, a concentrator plant 4, a boiler plant 5, a causticizing plant 6, an optional pulp pre-bleaching plant 3a, an optional pulp bleaching plant 3b; and a magnesium addition unit. Typically, the plants may have one or more equipments for the operation, i.e., the digester 1 may have one or more digesters, the washer plant 2 may have one or more washers, one or more dewaters, etc.

The magnesium addition unit is comprised in at least one of the washer plant 2, concentrator plant 4, boiler plant 5, causticizing plant 6, or more. For instance, if the magnesium addition unit is located at the boiler plant 5, a pumping leading the magnesium via a feeding pipeline may be in connection with the sesquisulfate feeding, taking advantage of the already installed, feeding the weak black liquor to the boiler, adding the magnesium to the weak black liquor before entering the boiler. In another embodiment, the magnesium addition unit may be located at the concentrator plant 4. In any case, the operation ultimately produces a green liquor with a magnesium to aluminum molar ratio of at least 3, preferably 4.

In any case, the present invention disclose a method of producing a green liquor having a molar ratio of magnesium to aluminum of at least 1, preferably at least 3, more preferably at least 4, by adding at least a magnesium to the black liquor, weak black liquor, or strong black liquor.

Due to variations in the levels of aluminum content introduced in the pulping process from calcium oxide, white liquor, wood, soil, and other, in connection to process variations, excess of magnesium may be desired. For instance, the methods of the present invention may employ addition of magnesium at a molar ratio of 0.04 to 5.0 mols of magnesium to aluminum present at the weak black liquor, strong black liquor or green liquor, preferably 3.0-5.0, more preferably 4.0.

As disclosed, the magnesium of the present invention may be any form of magnesium, such as a magnesium in free form, an oxide form, a cation form, a salt form, a hydroxide form, or mixtures thereof. For instance, the magnesium of the present invention may be a magnesium in a salt form. Suitable magnesium salts are magnesium sulphate, magnesium chloride, or mixtures thereof. Alternatively, an exemplary hydroxide source is magnesium hydroxide.

The aluminum present at the production inputs such as calcium oxide, white liquor, wood, and others, is preferably removed from the pulping process during the combustion step at the boiler plant 5 via formation of dregs rich in aluminum. The dregs are mostly easily removed from the green liquor in a filtration procedure, e.g. using X-filters, k7. A preferred compound formed that is removed is hydrotalcite (Mg₆Al₂(OH)₁₆CO₃.4H₂O), resulting in hydrotalcite rich dregs.

In one aspect, the method of the present invention is a method of producing hydrotalcite from a black liquor by the addition of producing hydrotalcite by the addition of at least 0.04-5.0 magnesium mol to the aluminum mol, preferably 3.0-5.0 magnesium mols to the aluminum mol, more preferably 4.0 magnesium mols to the aluminum mol present at the weak black liquor, strong black liquor, or combinations thereof.

Preferably, the magnesium is added during the recovery operation of the black liquor. The magnesium may be added to the weak black liquor, strong black liquor, or a combination thereof. In one preferred embodiment, the method of the present invention, the addition of 1 mol of magnesium is at least to the weak black liquor. In this sense, it is provided a method of forming hydrotalcite with the addition of magnesium to a weak black liquor, providing a green liquor with a proportion of magnesium to aluminum of least 1, preferably at least 3, more preferably 4. To achieve such ratio the magnesium is added from 0.04-5 mols of magnesium to the mol of aluminum, preferably from 3.0-5.0 mols of magnesium to the mol of aluminum, more preferably of 4.0 mols of magnesium to the mol of aluminum.

As discussed, the strong black liquor is combusted producing inorganics that are ultimately processed and converted to form white liquor. Due to this recovery operation, reducing the aluminum content at the green liquor, removing the aluminum rich dregs that form from the addition of magnesium to the recovery operation, a white liquor with low levels of aluminum may be achieved, reducing the overall aluminum amount present at the pulping process and also reducing the risks of loss of filterability and of stops in said process.

### EXAMPLES

The examples below illustrate some experiments and the results achieved by the inventors when using the methods described herein for the aluminum:

### A. Aluminum

Lab trials done in with different molar ratios using reference industrial green liquor showed that the addition of the higher molar ratios did not resulted in removal of the aluminum from the green liquor. Additionally, the time to filtrate it was negatively impacted, which can be seen in Table 1 below:

TABLE 1

| Treatments | Molar Ratio Mg/Al added in Green Liquor | Resulting Al in the filtrated Green Liquor |
|---|---|---|
| T0 (Reference Liquor) | 0,67 | 85 |
| T1 | 1 | 88,8 |
| T2 | 2 | 93 |
| T3 | 3 | 86 |
| T4 | 4 | 83,5 |
| T5 | 5 | 87,3 |

Addition of 4 mols of magnesium sulfate per 1 mol of aluminum was made to the black liquor as per the method of the present invention.

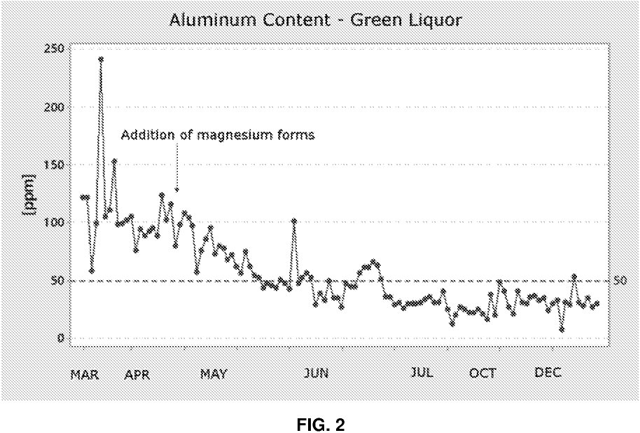

By monitoring the aluminum content of the resulting green liquor industrially it is possible to verify (FIG. 2) the content (in ppm) reduction in time after the addition of magnesium sulphate in black liquor.

The aforementioned examples are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. Method for reducing inorganic metals content in a Kraft process comprising adding at least a magnesium to a black liquor, weak black liquor, or strong black liquor of a pulping operation.

2. Method for reducing inorganic metals content in a Kraft process by adding at least a magnesium to a black liquor to provide a green liquor having a molar proportion of magnesium to inorganic metals of at least 1.

3. The method according to claim 1, wherein the magnesium is added at a proportion from 0.04 to 4 mols of magnesium to each inorganic metals mol at the black liquor.

4. The method according to claim 1, wherein the magnesium is added in a proportion of 1 mol of magnesium to each inorganic metals mol at the black liquor in a proportion of 3 mols of magnesium to each mol of inorganic metals at the black liquor.

5. Method according to claim 1, wherein the method reduces inorganic metals content in a pulping process by adding of at least a magnesium to the black liquor to provide a treated white liquor having an inorganic metals amount selected from the group consisting of up to 60 ppm up to 30 ppm, and up to 20 ppm.

6. The method according to claim 1, wherein the magnesium is added in a proportion from 0.04 to 4 ppm of magnesium to each inorganic metals mol at the black liquor.

7. The method according to claim 1, wherein the magnesium is added in a proportion of 1 ppm of magnesium to each ppm of inorganic metals at the black liquor in a proportion of 3 ppm of magnesium to each ppm of inorganic metals at the black liquor.

8. The method according to claim 1, wherein the molar ratio of magnesium to inorganic metals is of at least 0.04-5.0.

9. The method according to claim 1, wherein the magnesium is added to the black liquor before the recovery operation.

10. The method according to claim 1, wherein the magnesium is added to the weak black liquor before the evaporation step.

11. The method according to claim 1, wherein the magnesium is added to the strong black liquor before the recovery boiler step.

12. Method according to claim 1, wherein the step of adding at least a magnesium to one or more of black liquor, weak black liquor, or strong black liquor produces a green liquor having a molar ratio of magnesium to inorganic metals selected from the group consisting of at least 1 at least 3 and at least 4.

13. A Kraft a pulp mill comprising a digester, a washer plant, a concentrator plant, a boiler plant, a causticizing plant, optionally a pulp pre-bleaching plant, optionally a pulp bleaching plant, and a magnesium addition unit.

14. The mill of claim 13, wherein the magnesium addition unit is comprised in at least one of the concentrator plant 4, boiler plant 5, or combinations thereof.

15. The method according to claim 1, wherein the magnesium is added in a molar ratio of 0.04 to 5.0 mols of magnesium to inorganic metals present at the weak black liquor, strong black liquor or green liquor.

16. The method of claim 1, wherein the magnesium is a magnesium form in a free form, a cation form, a salt form, an oxide form, a hydroxide form, or mixtures thereof.

17. The method of claim 1, wherein the magnesium is a magnesium in a salt form.

18. The method of claim 17, wherein the magnesium is a magnesium sulphate, a magnesium chloride, or mixtures thereof.

19. Method according to claim 1, wherein the method produces hydrotalcite by the addition of at least 0.04-5.0 magnesium mol to the aluminum present at the weak black liquor, strong black liquor, or a combination thereof.

20. The method of claim 19 wherein the magnesium is added at least to the weak black liquor, strong black liquor, or combinations thereof.

21. The method of claim 19 wherein the magnesium is added at least to the weak black liquor.

22. Method according to claim 1, wherein the method forms of hydrotalcite, and wherein magnesium is added to a weak black liquor that provides a green liquor having a proportion of magnesium to aluminum selected from the group consisting of at least 1 at least 3, at least 4.

23. The method of claim 1, wherein the inorganic metal is aluminum, iron and/or manganese.
